(19) United States
(12) Patent Application Publication
(10) Pub. No.: US 2006/0080093 A1
(43) Pub. Date: Apr. 13, 2006

(54) Decoder

(76) Inventor: Kosuke Nishio, Osaka (JP)

Correspondence Address: MCDERMOTT WILL & EMERY LLP, 600 13TH STREET, N.W., WASHINGTON, DC, 20005-3096, US

(21) Appl. No.: 11/202,199

(22) Filed: Aug. 12, 2005

(30) Foreign Application Priority Data
Oct. 8, 2004 (JP) 2004-295737

(51) Int. Cl. G10L 21/00

(52) U.S. Cl. 704/228

(57) ABSTRACT

An encoded signal is input to an input section. A signal information analyzing section analyzes the signal information of the signal input to the input section and compares the analyzed signal information with EX-encoded signal information stored in a signal information database. Based on the comparison result, an operation mode switch signal is output to a mode switch controlling section. The input signal is decoded in an operation section.

### CROSS-REFERENCE TO RELATED APPLICATION

This application claims priority under 35 U.S.C. § 119(a) on Japanese Patent Application No. 2004-295737 filed on Oct. 8, 2004, the entire contents of the specification, drawings and claims of which are hereby incorporated by reference.

### BACKGROUND OF THE INVENTION

The present invention relates to a decoder for decoding encoded picture data or sound data.

Presently, picture data and sound data are converted to digital data, the information amount of the digital data is reduced using a low bit rate coding method, and the compressed digital data is then multiplexed. The multiplexed digital data is, for example, recorded in a DVD (Digital Versatile Disc), or the like, or distributed through a digital television system, the Internet, or the like.

Widely-known examples of picture data encoding include MPEG2, MPEG4, etc. Widely-known examples of sound data encoding include Dolby Digital, DTS (Digital Theater System), MPEG Audio, and a PCM method with no reduction in information amount, etc. It should be noted that Dolby Digital is a trademark of Dolby Laboratories Licensing Corporation, and DTS is a trademark of DTS, Inc.

Hereinafter, a signal (a group of signals) encoded by a sound data encoding method is referred to as “encoded sound data”. Such encoded sound data includes signals of a plurality of channels. For example, according to the Dolby Digital standards, the encoded sound data includes encoded signals of 6 channels (6ch) at the maximum. One of the 6 channels (6ch) is a low band signal having a small amount of information and is therefore expressed as “0.1”, and accordingly, the entire encoded sound data is expressed as “5.1ch”.

The Dolby Digital standards also define the information which indicates that signals of 7ch or more are downmixed to 6ch and then encoded. This is called Dolby Digital Surround EX technique (hereinafter, referred to as “EX technique”). Herein, encoding with the EX technique is referred to as “EX-encoding”, and EX-encoded sound data is referred to as “EX sound data”. Decoding EX sound data is referred to as “EX-decoding”.

FIG. 5A is a block diagram which illustrates EX-encoding of sound data and encoding of EX sound data to encoded sound data. FIG. 5B is a block diagram which illustrates decoding of encoded sound data and EX-decoding of EX sound data. Such a Dolby Digital technique has been disclosed on the Internet (ATSC Standard: Digital Audio Compression (AC-3), Revision A). Herein, in the case of a DVD player, a digital television system, and the like, input encoded sound data is decoded and subjected to downmix and volume adjustment according to the number of loudspeakers before the sound data is output.

However, when in reproduction of encoded sound data EX sound data has been encoded, there is a possibility that the EX sound data is not appropriately decoded. Hereinafter, a conventional decoder is described.

FIG. 6 is a block diagram showing a structure of a conventional decoder 100. In this example, it is assumed that the decoder 100 is a DVD player. As shown in FIG. 6, the decoder 100 includes an input section 110, an operation section 120, an output section 130, a signal information analyzing section 140, and a mode switch controlling section 150.

The input section 110 receives an encoded and multiplexed signal recorded in a recording medium, such as a DVD, or the like.

The operation section 120 decodes the signal received at the input section 110 into picture data and sound data.

The output section 130 outputs the picture data and sound data generated at the operation section 120.

The signal information analyzing section 140 analyzes the signal information of the signal received at the input section 110. In this example, the information about EX-encoding is extracted, and an analysis result of the extracted information is output as an output signal.

The mode switch controlling section 150 determines, based on the output signal from the signal information analyzing section 140 and external control, whether or not EX-decoding is performed in the operation section 120, and switches its operation mode according to the determination.

Next, information about EX sound data is shown in FIG. 7. According to the table of FIG. 7, the information indicative of whether or not encoded sound data has been EX-encoded includes four cases. Specifically, “EX-encoded (10)”, “not EX-encoded (01)”, “not especially indicated whether or not EX-encoded (00)”, and “Reserved (11)”. Such information is superposed on encoded sound data of the Dolby Digital standards.

The decoder 100 determines based on the information about EX sound data whether or not EX-decoding is performed. The condition to be discussed herein is the case of “not especially indicated whether or not EX-encoded”. In this case, the decoder 100 cannot make a determination as to execution of EX-decoding, and therefore, the mode has to be set to any of “EX-decoding is performed at every occasion” and “EX-decoding is not performed at any occasion”.

For example, if the decoder 100 is set to the mode of “EX-decoding is not performed at any occasion”, EX-decoding is not performed in the case where the information superposed on encoded sound data indicates “not especially indicated whether or not EX-encoded” at an authoring step even when a DVD manual describes that it is EX sound data.

If the mode is set to “EX-decoding is performed at every occasion”, EX-decoding is also performed on encoded sound data in which EX sound data is not encoded.

As described above, if EX sound data has been encoded, the EX sound data cannot be appropriately EX-decoded with some settings of decoding. To solve this problem, a user of the DVD player may change the setting of the DVD player according to the DVD disc manual. However, changing the setting as necessary is a troublesome effort and therefore undesirably deteriorates the convenience.

Another problem of the conventional decoder is reproduction of data with downmix or volume which is not intended by a producer of the data. The downmix coefficients and the play volume can be set at the time of authoring, but conversely, there is no more chance to set these parameters after the authoring step.

### SUMMARY OF THE INVENTION

The present invention was conceived in view of the above circumstances. An object of the present invention is to appropriately EX-decode an EX-encoded signal.

In view of the above problems, the present invention was conceived such that the decoding mode and the sound data output mode are changed according not to information superposed on encoded sound data but to medium information of a medium in which encoded sound data is stored or transmission data information based on which encoded sound data is transmitted.

According to the present invention, a decoder comprises: an input section at which an encoded signal is input; an operation section for performing an operation on the signal input at the input section; an output section for outputting a signal obtained by the operation of the operation section; a signal information analyzing section for analyzing signal information of the signal input at the input section and compares the analyzed signal information with signal information stored in a database to output an output signal based on a result of the comparison; and an operation mode switch section for switching an operation mode of the operation section based on the output signal from the signal information analyzing section.

According to the present invention, there is provided a database providing service carried out using the above-described decoder.

According to the present invention, there is provided a database system wherein an encoded signal is decoded using the above-described decoder and a personal computer which includes a database.

According to the present invention, there is provided a broadcasting system which uses the above-described decoder.

According to the present invention, there is provided a computer program which instructs a computer to execute the steps of: inputting an encoded signal; performing an operation on the input encoded signal; outputting a signal obtained by the operation; analyzing signal information of the input encoded signal and comparing the analyzed signal information with signal information stored in a database to output an output signal based on a result of the comparison; and switching an operation mode of the operation based on the output signal.

According to the present invention, there is provided a computer-readable recording medium which contains the above-described computer program.

With the above-described decoder of the present invention, decoding can be appropriately performed without information which indicates that data has been Dolby Digital Surround EX-encoded. Further, the downmix and the volume level can be set separately even when such information is not superposed on a stream.

According to the database providing service of the present invention, a system can be realized wherein the decoding mode and the sound data output mode are changed according not to information superposed on encoded sound data but to medium information of a medium in which encoded sound data is stored or transmission data information based on which encoded sound data is transmitted.

According to the system of the present invention, a network or broadcasting system can be realized wherein the decoding mode and the sound data output mode are changed according not to information superposed on encoded sound data but to medium information of a medium in which encoded sound data is stored or transmission data information based on which encoded sound data is transmitted.

According to the computer program and the recording medium containing the same of the present invention, the decoding mode and the sound data output mode are changed according not to information superposed on encoded sound data but to medium information of a medium in which encoded sound data is stored or transmission data information based on which encoded sound data is transmitted.

### BRIEF DESCRIPTION OF THE DRAWINGS

FIG. 1 is a block diagram showing a structure of a decoder according to embodiment 1 of the present invention.

FIG. 2 is a block diagram showing a structure of a decoder according to embodiment 2 of the present invention.

FIG. 3 is a block diagram showing a structure of a decoder according to embodiment 3 of the present invention.

FIG. 4 is a block diagram showing a structure of a decoder according to embodiment 4 of the present invention.

FIG. 5 is a block diagram illustrating a general concept of EX technique.

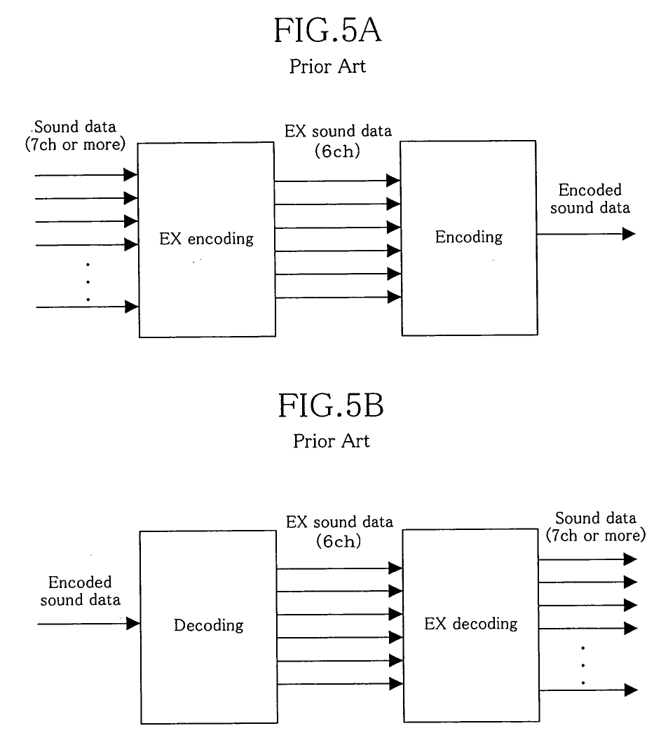

FIG. 6 is a block diagram showing a structure of a conventional decoder.

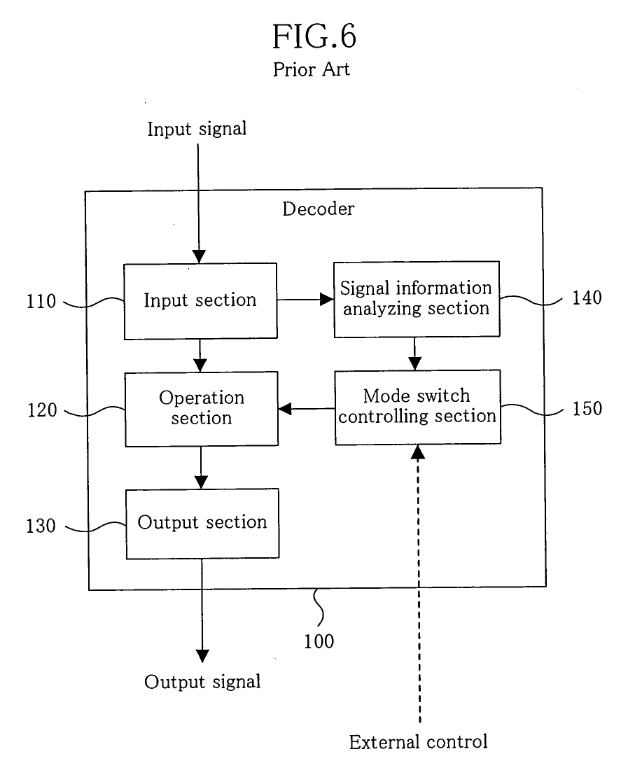

FIG. 7 illustrates information that indicates the status of EX sound data.

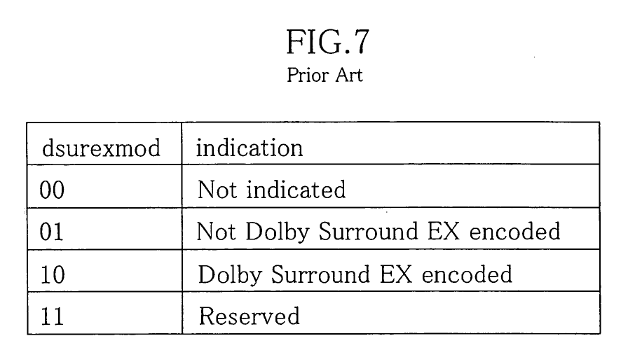

### DESCRIPTION OF THE PREFERRED EMBODIMENTS

Hereinafter, embodiments of the present invention are described in detail with reference to the drawings. The following descriptions of the preferred embodiments are merely exemplary in essence and do not intend to limit the scope of the invention or the applications or uses of the invention.

### Embodiment 1

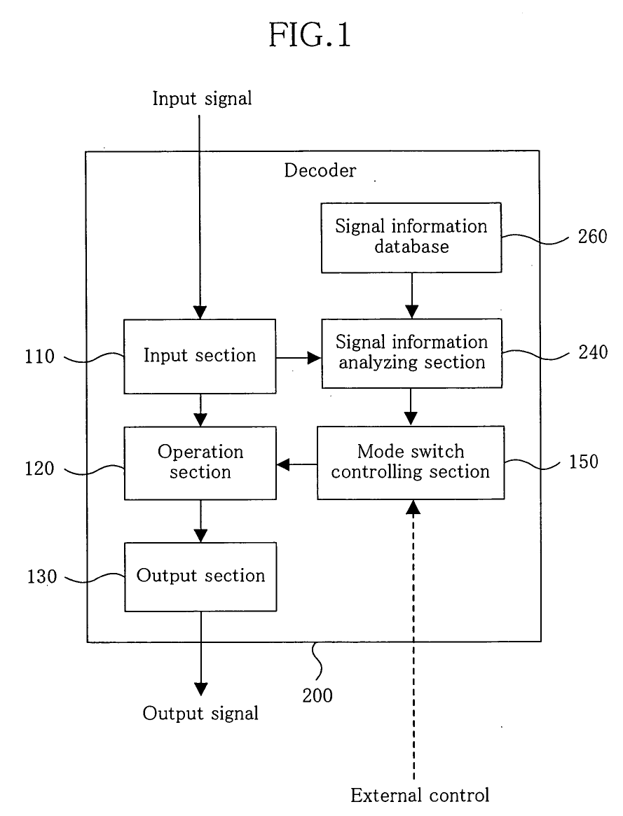

FIG. 1 is a block diagram showing a structure of a decoder 200 according to embodiment 1 of the present invention. One of the differences of embodiment 1 from the above-described conventional example is addition of a database which is referred as to the disc information of an input signal. Hereinafter, the same components as those of the conventional example are denoted by the same reference numerals, and only the differences are described. (The same applies to embodiments 2-4).

As shown in FIG. 1, the decoder 200 includes an input section 110, an operation section 120, an output section 130, a signal information analyzing section 240, a mode switch controlling section 150, and a signal information database 260. Specifically, the following descriptions are given on an assumption that the decoder 200 is a DVD player, and the operation section 120 is an AV decoding section. The same applies to embodiments 2-4.

The signal information database 260 stores EX-encoded DVD disc information.

The signal information analyzing section 240 extracts information about EX-encoding from the signal information of an input signal received at the input section 110 and, on the other hand, extracts the disc information of the input signal. The signal information analyzing section 240 compares the extracted disc information with the EX-encoded DVD disc information stored in the signal information database 260.

If the comparison result indicates that the compared disc information match each other, the signal information analyzing section 240 determines that the input signal has been EX-encoded and rewrites the information about EX-encoding so as to indicate “EX-encoded”. Then, the rewritten information is output to the mode switch controlling section 150.

Although in this example the signal information analyzing section 240 rewrites the information about EX-encoding, the means for switching the operation mode of the operation section 120 is not especially limited to this method. The same applies to embodiments 2-4.

With the above structure, a determination as to whether or not EX-decoding is to be performed can be made without external user control. Especially, this is effective for already-marketed DVD discs and therefore possesses high industrial applicability.

In embodiment 1 of the present invention, the information about EX-encoding has been described, but the present invention is not limited thereto. For example, the concept of embodiment 1 is applicable to downmix, volume level control, etc., in the same fashion. The same applies to embodiments 2-4.

In embodiment 1 of the present invention, the decoder 200 is a DVD player, and a determination as to EX-decoding is made using the DVD disc information, but the present invention is not limited thereto. For example, the concept of embodiment 1 is applicable to distribution of picture and sound through digital television and communication systems, or the like. In this case, a determination as to EX-encoding can be made using program information, or the like. Alternatively, different information may be transmitted. The same applies to embodiments 2-4.

The above processes can be realized not only by hardware, as a matter of course, but also by software. Alternatively, part of the processes may be realized by hardware, the remaining part by software. The same applies to embodiments 2-4.

### Embodiment 2

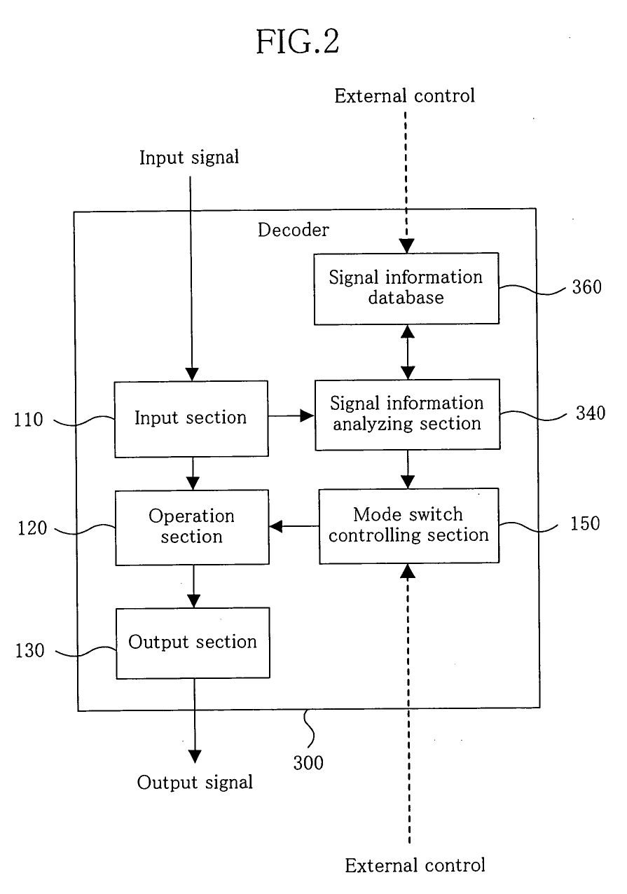

FIG. 2 is a block diagram showing a structure of a decoder 300 according to embodiment 2 of the present invention. As shown in FIG. 2, the decoder 300 includes an input section 110, an operation section 120, an output section 130, a signal information analyzing section 340, a mode switch controlling section 150, and a signal information database 360.

The signal information database 360 stores EX-encoded DVD disc information.

The signal information analyzing section 340 extracts information about EX-encoding from the signal information of an input signal received at the input section 110 and, on the other hand, extracts the disc information of the input signal. The signal information analyzing section 340 compares the extracted disc information with the EX-encoded DVD disc information stored in the signal information database 360.

If the comparison result indicates that the compared disc information match each other, the signal information analyzing section 340 determines that the input signal has been EX-encoded and rewrites the information about EX-encoding so as to indicate “EX-encoded”. Then, the rewritten information is output to the mode switch controlling section 150.

The data stored in the signal information database 360 can be updated by external control. For example, DVD disc information currently being decoded is stored in the signal information database 360. In this case, the data stored in the signal information database 360 can be updated by a user.

With the above structure, a determination as to whether or not EX-decoding is to be performed can be made without external user control. Especially, this is effective for already-marketed DVD discs and therefore possesses high industrial applicability.

### Embodiment 3

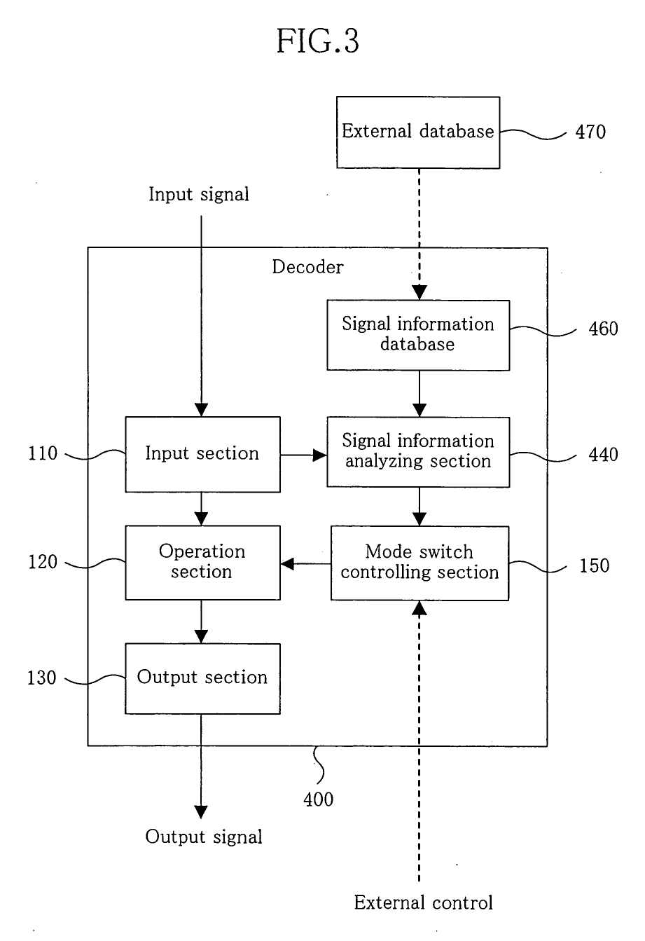

FIG. 3 is a block diagram showing a structure of a decoder 400 according to embodiment 3 of the present invention. As shown in FIG. 3, the decoder 400 includes an input section 110, an operation section 120, an output section 130, a signal information analyzing section 440, a mode switch controlling section 150, and a signal information database 460. The decoder 400 further includes a communication port, through which the decoder 400 is connected to an external database 470.

The external database 470 stores EX-encoded DVD disc information. The external database 470 is provided outside the decoder 400.

The signal information database 460 stores EX-encoded DVD disc information.

The signal information analyzing section 440 extracts information about EX-encoding from the signal information of an input signal received at the input section 110 and, on the other hand, extracts the disc information of the input signal. The signal information analyzing section 440 compares the extracted disc information with the EX-encoded DVD disc information stored in the signal information database 460.

If the comparison result indicates that the compared disc information match each other, the signal information analyzing section 440 determines that the input signal has been EX-encoded and rewrites the information about EX-encoding so as to indicate “EX-encoded”. Then, the rewritten information is output to the mode switch controlling section 150.

The signal information database 460 has a communication port, through which the signal information database 460 is connected to the external database 470. With this structure, the data stored in the signal information database 460 can be updated.

With the above structure, a determination as to whether or not EX-decoding is to be performed can be made without external user control. Especially, this is effective for already-marketed DVD discs and therefore possesses high industrial applicability.

### Embodiment 4

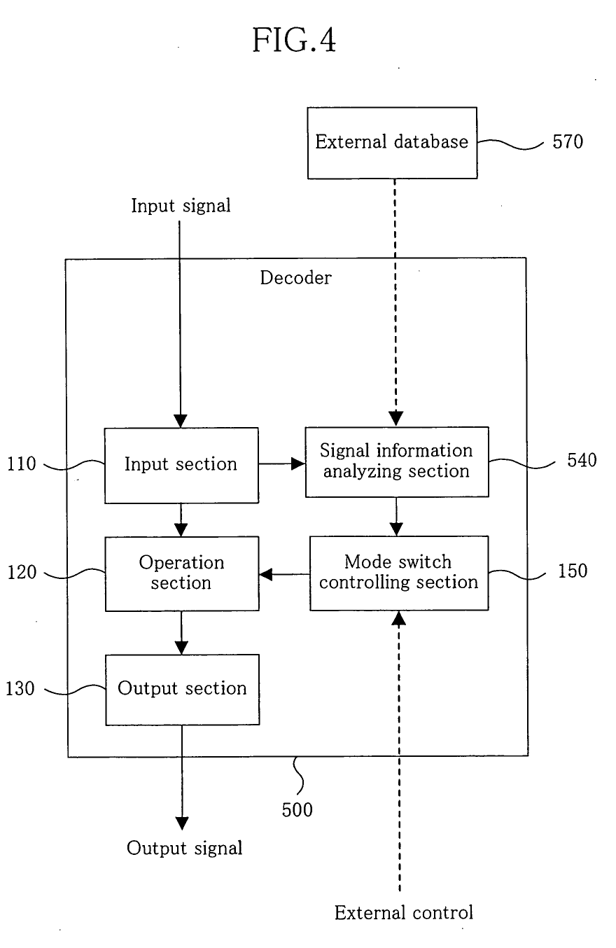

FIG. 4 is a block diagram showing a structure of a decoder 500 according to embodiment 4 of the present invention. As shown in FIG. 4, the decoder 500 includes an input section 110, an operation section 120, an output section 130, a signal information analyzing section 540, and a mode switch controlling section 150. The decoder 500 further includes a communication port, through which the decoder 500 is connected to an external database 570.

The external database 570 stores EX-encoded DVD disc information. The external database 570 is provided outside the decoder 500.

The signal information analyzing section 540 extracts information about EX-encoding from the signal information of an input signal received at the input section 110 and, on the other hand, extracts the disc information of the input signal. The signal information analyzing section 540 compares the extracted disc information with the EX-encoded DVD disc information stored in the external database 570.

If the comparison result indicates that the compared disc information match each other, the signal information analyzing section 540 determines that the input signal has been EX-encoded and rewrites the information about EX-encoding so as to indicate “EX-encoded”. Then, the rewritten information is output to the mode switch controlling section 150.

With the above structure, a determination as to whether or not EX-decoding is to be performed can be made without external user control. Especially, this is effective for already-marketed DVD discs.

The decoder of the present invention possesses a highly practical effect such that decoding can be appropriately performed without information which indicates that data has been Dolby Digital Surround EX-encoded. Thus, the decoder of the present invention is useful as an AV decoder and possesses high industrial applicability.

What is claimed is:

1. A decoder, comprising:
an input section at which an encoded signal is input;
an operation section for performing an operation on the signal input at the input section;
an output section for outputting a signal obtained by the operation of the operation section;
a signal information analyzing section for analyzing signal information of the signal input at the input section and compares the analyzed signal information with signal information stored in a database to output an output signal based on a result of the comparison; and
an operation mode switch section for switching an operation mode of the operation section based on the output signal from the signal information analyzing section.

2. The decoder of claim 1, wherein the database is incorporated in the decoder.

3. The decoder of claim 1, wherein:
the database is incorporated in the decoder; and
data stored in the database is updated from the outside of the decoder.

4. The decoder of claim 1, wherein:
the database is incorporated in the decoder; and
data stored in the database is updated by a communication from the outside of the decoder.

5. The decoder of claim 1, wherein:
the database is provided outside the decoder; and
data stored in the database is referred to by a communication.

6. The decoder of claim 1, wherein the encoded signal input at the input section contains information specific to a recording medium in which the signal has been recorded.

7. The decoder of claim 1, wherein the encoded signal input at the input section contains information specific to a transmission program by which the signal has been transmitted.

8. The decoder of claim 1, wherein the encoded signal input at the input section contains information by which the signal is specified.

9. The decoder of claim 1, wherein the operation mode of the operation section indicates the decoding format for decoding the encoded signal.

10. The decoder of claim 9, wherein the decoding format is Dolby Digital Surround EX format.

11. The decoder of claim 1, wherein the operation mode of the operation section indicates an output process which is performed on a signal obtained by decoding the encoded signal.

12. The decoder of claim 11, wherein the output process is a downmix process.

13. The decoder of claim 11, wherein the output process is a volume adjustment process.

14. A database providing service carried out using the decoder of claim 1.

15. A database system wherein an encoded signal is decoded using the decoder of claim 1 and a personal computer which includes a database.

16. A broadcasting system which uses the decoder of claim 1.

17. A computer program which instructs a computer to execute the steps of:
inputting an encoded signal;
performing an operation on the input encoded signal;
outputting a signal obtained by the operation;
analyzing signal information of the input encoded signal and comparing the analyzed signal information with signal information stored in a database to output an output signal based on a result of the comparison; and
switching an operation mode of the operation based on the output signal.

18. A computer-readable recording medium which contains the computer program of claim 17.
